(19) United States
(12) Patent Application Publication
(10) Pub. No.: US 2019/0218857 A1
(43) Pub. Date: Jul. 18, 2019

(54) WINDOW BLINDS

(71) Applicant: Shan-Chi Chuang, New Taipei City (TW)

(72) Inventor: Shan-Chi Chuang, New Taipei City (TW)

(73) Assignee: ABO WINDOW FASHION CORP., Chino, CA (US)

(21) Appl. No.: 15/871,860

(22) Filed: Jan. 15, 2018

(51) Int. Cl. E06B 9/36

(52) U.S. Cl. CPC E06B 9/362; E06B 9/368

(57) ABSTRACT

A window blinds may comprise a headrail, a plurality of track bars, and a plurality of blinds. The headrail has a plurality of parallel rail portions, and two covers respectively cover two lateral ends of the headrail. Each of guiding members formed at an upper portion of the track bar is configured to be received in the rail portion of the headrail. Each of the track bars comprises a connecting groove at a lower portion thereof, and each of the blinds is connected to a strip at an upper edge thereof which is configured to be coupled in the connecting groove. The guiding members of the track bars are arranged and limited in the rail portion of the headrail, thereby enabling the window blinds to be assembled and used easily and reducing the sizes of the headrail and the track bars.

### FIELD OF THE INVENTION

The present invention relates to a window shade and more particularly to window blinds.

### BACKGROUND OF THE INVENTION

Referring to FIG. 11, a conventional window blinds (40) comprises a supporting base (41), and a plurality of parallel sliding grooves (42) are formed on the supporting base (41). A plurality of track bars (43) are respectively installed in the sliding grooves (42), and each of the track bars (43) has two sliding wheels (431) which are configured to be coupled in the sliding groove (42). Moreover, each of the track bases (43) is connected to a blind (44), and a lift cord (45) installed in the supporting base (41) is adapted to drive the track base (43). Furthermore, a plurality of locating blocks (432) are formed on the track base (43) to limit shifts of the track base (43).

However, the conventional window blinds is disadvantageous because: each of the track bars (43) is installed in the sliding groove (42) of the supporting base (41) through the sliding wheels (431), and the sliding groove (42) needs to be manufactured wider according to the size of the sliding wheels such that the manufacturing and packing costs of the supporting base (41) are raised and the installation of the window blinds is also more difficult; and (ii) the blinds (44) are respectively installed on the track bars (43) through male-female buckles and adhesives, and not only the installing process costs more labors but also the blinds (44) may not be arranged tidily. Therefore, there remains a need for a new and improved design for a window blinds to overcome the problems presented above.

### SUMMARY OF THE INVENTION

The present invention provides a window blinds which comprises a headrail, a plurality of track bars, and a plurality of blinds. The headrail has a plurality of rail portions which are parallel and respectively configured to receive the track bars, and each of the rail portions has a block portion at a bottom portion thereof. Two covers respectively cover two lateral ends of the headrail, and each of guiding members formed at an upper portion of the track bar is configured to be received in the rail portion of the headrail. Each of pairs of first sliding members is configured to couple together to clamp the guiding member, and the pairs of the first sliding members are respectively received in the rail portions. Each of the track bars has a horizontal engaging groove at a middle portion of one surface thereof and comprises a horizontal slide groove on the other surface thereof located at a position corresponding to the engaging groove. Each of the engaging grooves is coupled with a second sliding member adjacent to a first end of the track bar, and the second sliding member formed in L-shape has a hook portion which is configured to extend from a first end of the engaging groove to a first end of the sliding groove. Furthermore, the thickness of the second sliding member is greater than the depth of the engaging groove such that a portion of the second sliding member protruding from the engaging groove is configured to couple in the sliding groove of one adjacent track bar. A corner edge of the L-shaped second sliding member has an engaging recess which is formed at a position corresponding to the hook portion of the adjacent track bar when the track bars are side by side. Each of blocking members is configured to be coupled in the sliding groove adjacent to a second end of the track bar. Each of the track bars comprises a connecting groove at a lower portion thereof, and a lower portion of the connecting groove has two blocking edges respectively protruding from two inner surfaces thereof at corresponding positions. Each of the blinds is connected to a strip at an upper edge thereof, and each of the strips made of plastic material is configured to be coupled in the connecting groove of the track bar. More specifically, the strip is configured to clamp and cover the upper edge of the blind, and the strip and the blind are adapted to be sewed together through a row of horizontal stitches. Each of two lateral surfaces of the strip has a flat surface, and an arc-shaped locating head is formed at an upper end of the strip. Additionally, each of two lateral ends of the strip comprises a cutting edge.

In one embodiment, each of the engaging grooves has a first engaging hole and a second engaging hole adjacent to the first end of the track bar while each of the sliding grooves comprises a third engaging hole adjacent to the second end of the track bar.

In another embodiment, each of the second sliding members comprises a first locating protrude and a through hole, and the first locating protrude is configured to engage with the first engaging hole while the through hole is adapted to align with the second engaging hole; a locating bolt is configured to penetrate through the through hole and the second engaging hole to secure the second sliding member on the track bar.

In still another embodiment, a locating member protruding from an upper surface of the second sliding member is configured to limit the second sliding member in the sliding groove of the adjacent track bar.

In a further embodiment, each of the blocking members has a plurality of second locating protrudes at a top edge and a bottom edge thereof, and the second locating protrudes are configured to be coupled in the sliding groove of the track bar, and a third locating protrude protruding from a lateral surface of the blocking member is adapted to engage with the third engaging hole of the sliding groove.

In still a further embodiment, the portion of the second sliding member of the innermost track bar protruding from the engaging groove is not coupled with any sliding groove, and a lock ring installed on an outer surface of the second sliding member of the innermost track bar is adapted to connect to a lever to move the window blinds.

In a particular embodiment, the track bars are connected to and moved through a lift cord.

In an advantageous embodiment, the sliding groove of the outermost track bar is not coupled with the second sliding member such that the outermost track bar has no the blocking member; the first sliding member of the outermost track bar has an engaging protrude to engage with an edge of the headrail.

In a preferred embodiment, each of the blinds is connected to the two strips at the upper edge and a lower edge thereof, and the strip at the lower edge of the blind has a weight at a lower portion thereof.

Comparing with conventional window blinds, the present invention is advantageous because: (i) the guiding members of the track bars are arranged and limited in the rail portion of the headrail through the first sliding members, thereby enabling the window blinds to be assembled and used easily and reducing the sizes of the headrail and the track bars; (ii) each of the blinds is sewed with the strip at the upper edge thereof to enhance strength, and each of the two lateral ends of the strip has the cutting edge to enable the blind to be easily installed on the track bar; (iii) the strip received in the connecting groove can enable the blind to be firmly secured on the track bar, thereby lowering labor costs; and (iv) the locating head formed at the upper end of the strip is adapted to bear against the inner wall of the connecting groove, and the friction between the locating head and the connecting groove is configured to secure the blind on the track bar.

### BRIEF DESCRIPTION OF THE DRAWINGS

FIG. 1 is a three-dimensional assembly view of a window blinds in the present invention.

FIG. 2 is an exploded view of a headrail and a plurality of track bars of the window blinds in the present invention.

FIG. 3 is an exploded view of the track bars and a blind of the window blinds in the present invention.

FIG. 3-1 is an enlarged view of a first sliding member of the window blinds in the present invention.

FIG. 3-2 is an enlarged view of another embodiment of the first sliding member of the window blinds in the present invention.

FIG. 3-3 is an enlarged view of a second sliding member of the window blinds in the present invention.

FIG. 3-4 is an enlarged view of another embodiment of the second sliding member of the window blinds in the present invention.

FIG. 3-5 is an enlarged view of a blocking member of the window blinds in the present invention.

FIG. 4 is a front view of the window blinds of the present invention.

FIG. 5 is a sectional view along line A-A of FIG. 4.

FIG. 6 is a sectional view along line B-B of FIG. 4.

FIG. 7 is a sectional view along line C-C of FIG. 4.

FIG. 8 is a schematic view illustrating the innermost track bar of the window blinds is pulled out.

FIG. 9 is a schematic view of the window blinds of the present invention is fully pulled out into an expanded position.

FIG. 10 is a schematic view of the window blinds of the present invention is fully pulled out through a lift cord.

FIG. 11 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

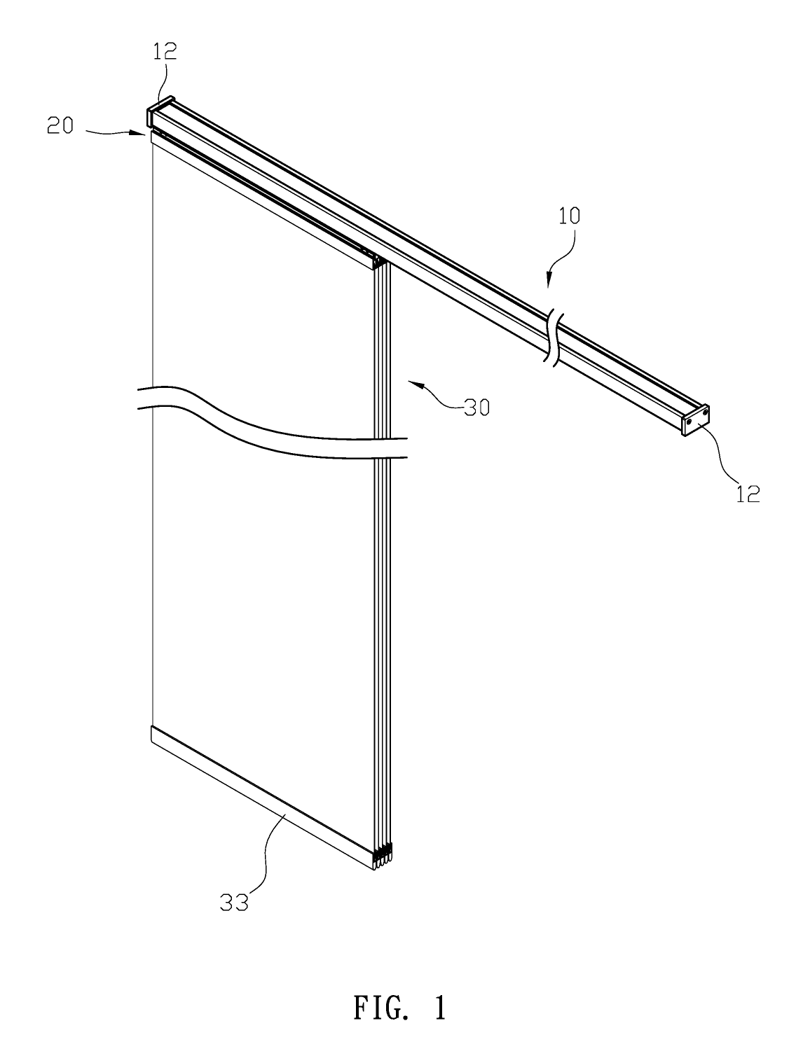

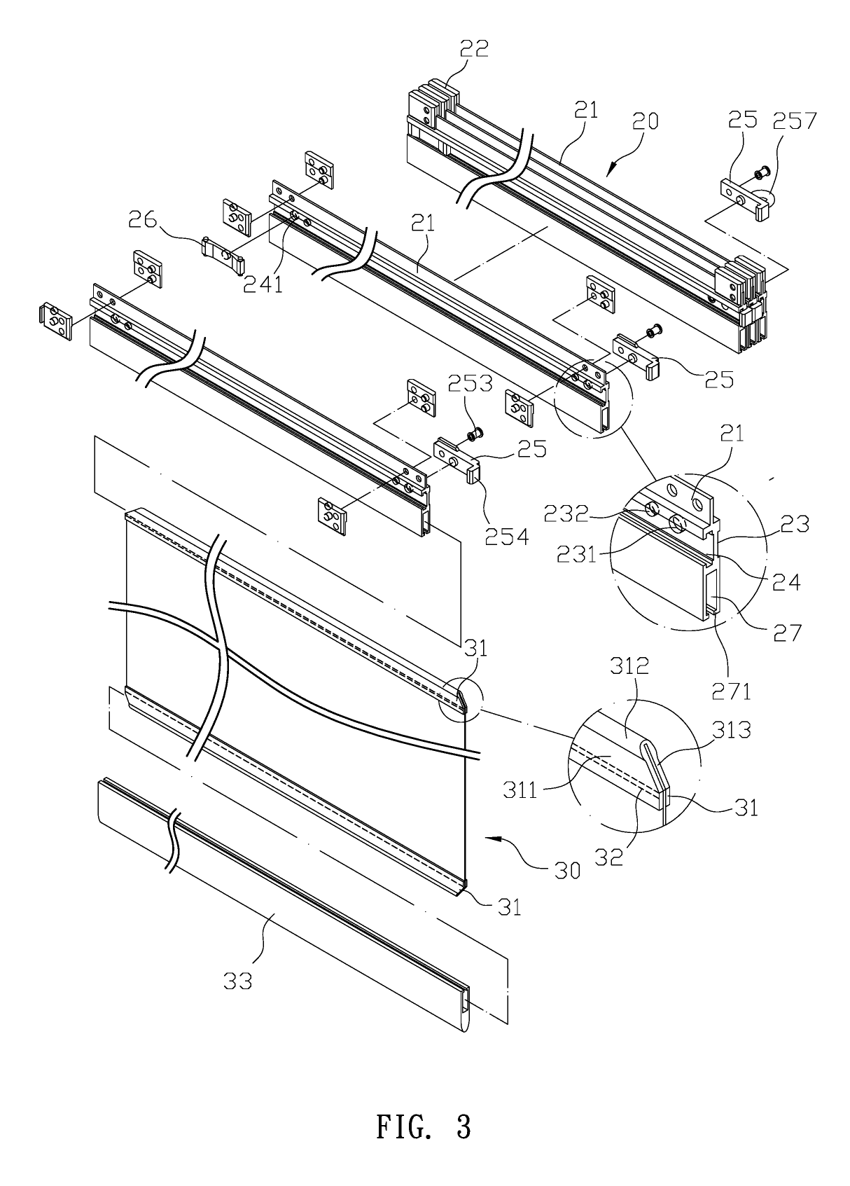

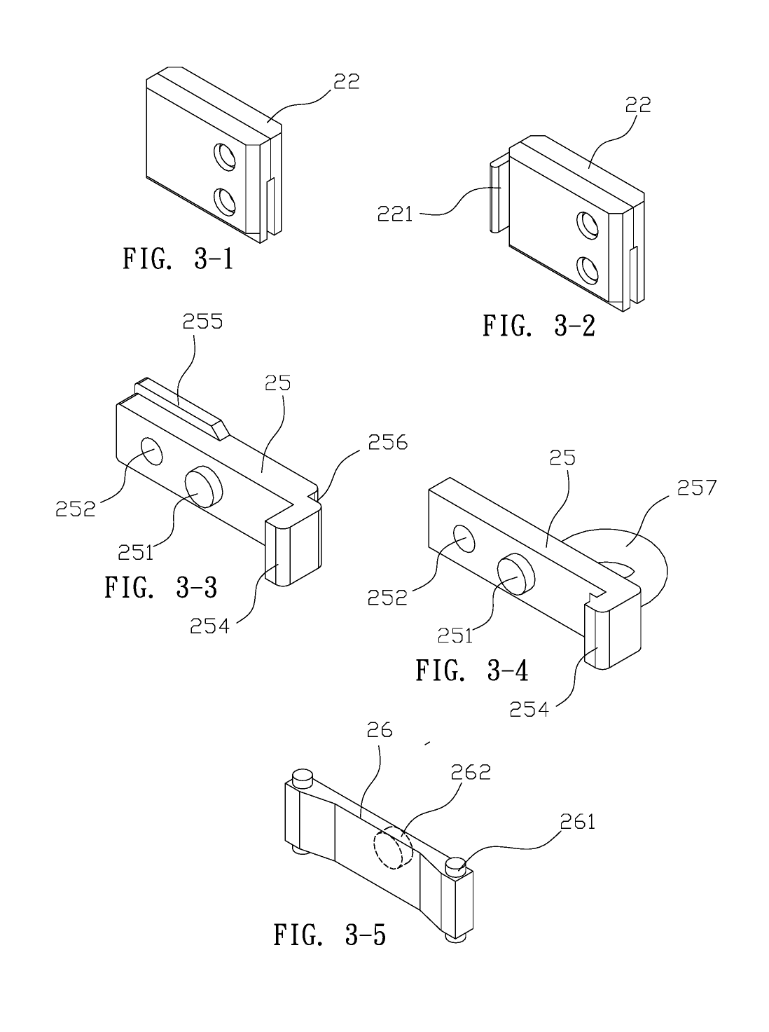

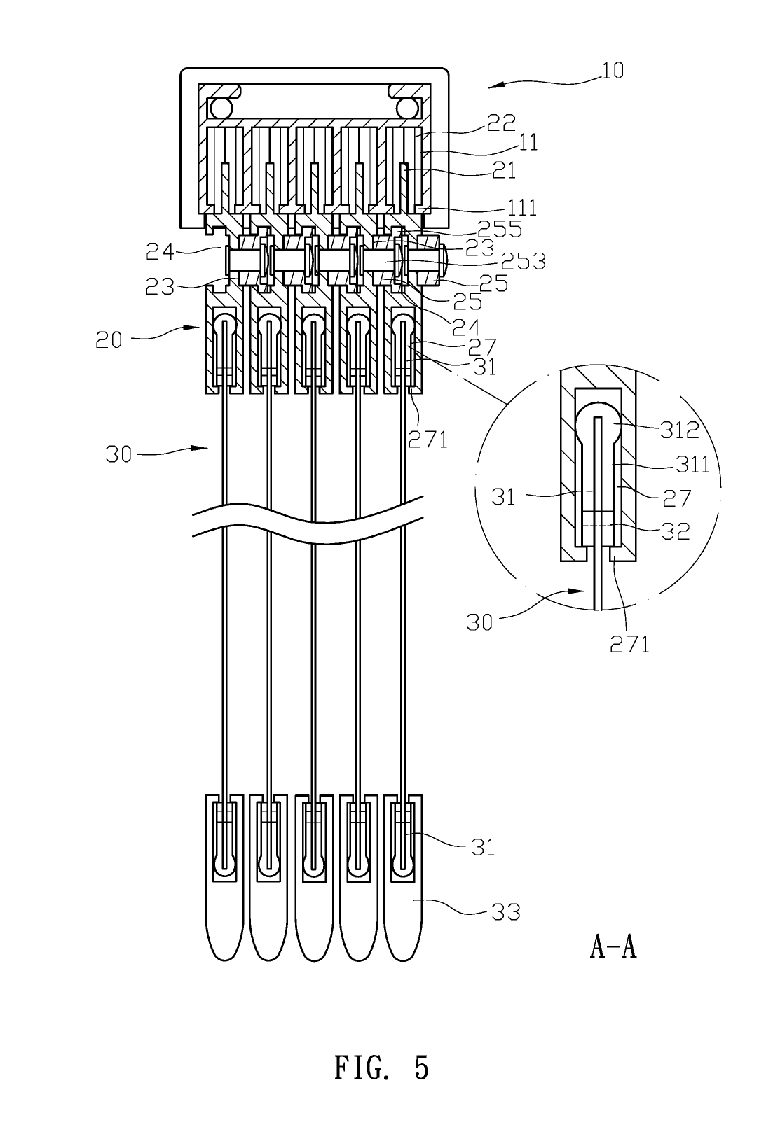

Referring to FIGS. 1 to 3, the present invention provides a window blinds which comprises a headrail (10), a plurality of track bars (20), and a plurality of blinds (30). The headrail (10) has a plurality of rail portions (11) which are parallel and respectively configured to receive the track bars (20), and each of the rail portions (11) has a block portion (111) at a bottom portion thereof. Two covers (12) respectively cover two lateral ends of the headrail (10), and each of guiding members (21) formed at an upper portion of the track bar (20) is configured to be received in the rail portion (11) of the headrail (10). Each of pairs of first sliding members (22) is configured to couple together to clamp the guiding member (21), and the pairs of the first sliding members (22) are respectively received in the rail portions (11) (as shown in FIGS. 3 and 3-1). Each of the track bars (20) has a horizontal engaging groove (23) at a middle portion of one surface thereof and comprises a horizontal slide groove (24) on the other surface thereof located at a position corresponding to the engaging groove (23). Additionally, each of the engaging grooves (23) has a first engaging hole (231) and a second engaging hole (232) adjacent to a first end of the track bar (20) while each of the sliding grooves (24) comprises a third engaging hole (241) adjacent to a second end of the track bar (20). Furthermore, each of the engaging grooves (23) is coupled with a second sliding member (25), and the second sliding member (25) comprises a first locating protrude (251) and a through hole (252) (as shown in FIG. 3-3). The first locating protrude (251) is configured to engage with the first engaging hole (231), and the through hole (252) is adapted to align with the second engaging hole (232). Also, a locating bolt (253) is configured to penetrate through the through hole (252) and the second engaging hole (232) to secure the second sliding member (25) on the track bar (20). The second sliding member (25) formed in L-shape has a hook portion (254) which is configured to extend from a first end of the engaging groove (23) to a first end of the sliding groove (24). Furthermore, the thickness of the second sliding member (25) is greater than the depth of the engaging groove (23) such that a portion of the second sliding member (25) protruding from the engaging groove (23) is configured to couple in the sliding groove (24) of an adjacent track bar (20). A locating member (255) protruding from an upper surface of the second sliding member (25) is configured to limit the second sliding member (25) in the sliding groove (24) of the adjacent track bar (20). Moreover, a corner edge of the L-shaped second sliding member (25) has an engaging recess (256) which is formed at a position corresponding to the hook portion (254) of the adjacent track bar (20) when the track bars (20) are side by side. Each of blocking members (26) configured to be coupled in the sliding groove (24) adjacent to the second end of the track bar (20) has a plurality of second locating protrudes (261) at a top edge and a bottom edge thereof (as shown in FIG. 3-5), and the second locating protrudes (261) are configured to be coupled in the sliding groove (24) of the track bar (20). Furthermore, each of the blocking members (26) has a third locating protrude (262) formed at a lateral surface thereof, and the third locating protrude (262) is adapted to engage with the third engaging hole (241) of the sliding groove (24). Also, each of the track bars (20) comprises a connecting groove (27) at a lower portion thereof, and a lower portion of the connecting groove (27) has two blocking edges (271) respectively protruding from two inner surfaces thereof at corresponding positions. Each of the blinds (30) is connected to a strip (31) at an upper edge thereof, and each of the strips (31) made of plastic material is configured to be coupled in the connecting groove (27) of the track bar (20). More specifically, the strip (31) is configured to clamp and cover the upper edge of the blind (30), and the strip (31) and the blind (30) are adapted to be sewed together through a row of horizontal stitches (32). Furthermore, each of two lateral surfaces of the strip (31) has a flat surface (311), and an arc-shaped locating head (312) is formed at an upper end of the strip (31). Additionally, each of two lateral ends of the strip (31) comprises a cutting edge (313).

In one embodiment, each of the blinds (30) is connected to the two strips (31) at the upper edge and a lower edge thereof, and the strip (31) at the lower edge of the blind (30) has a weight (33) at a lower portion thereof.

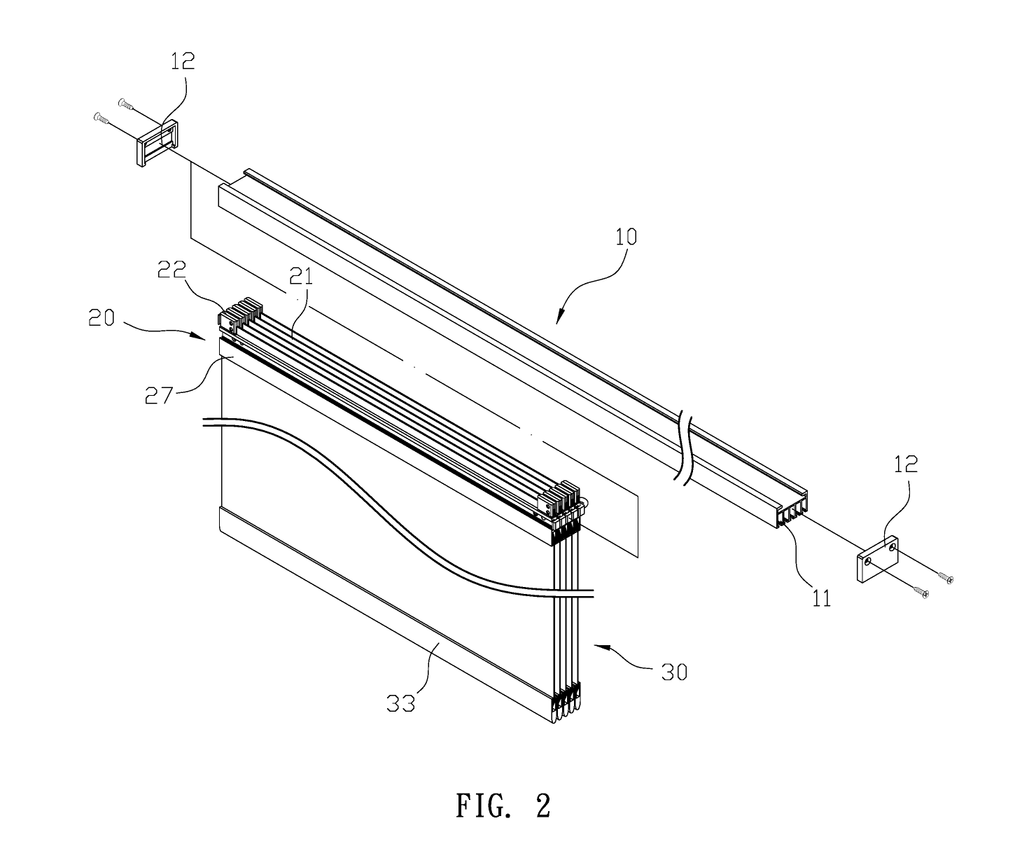

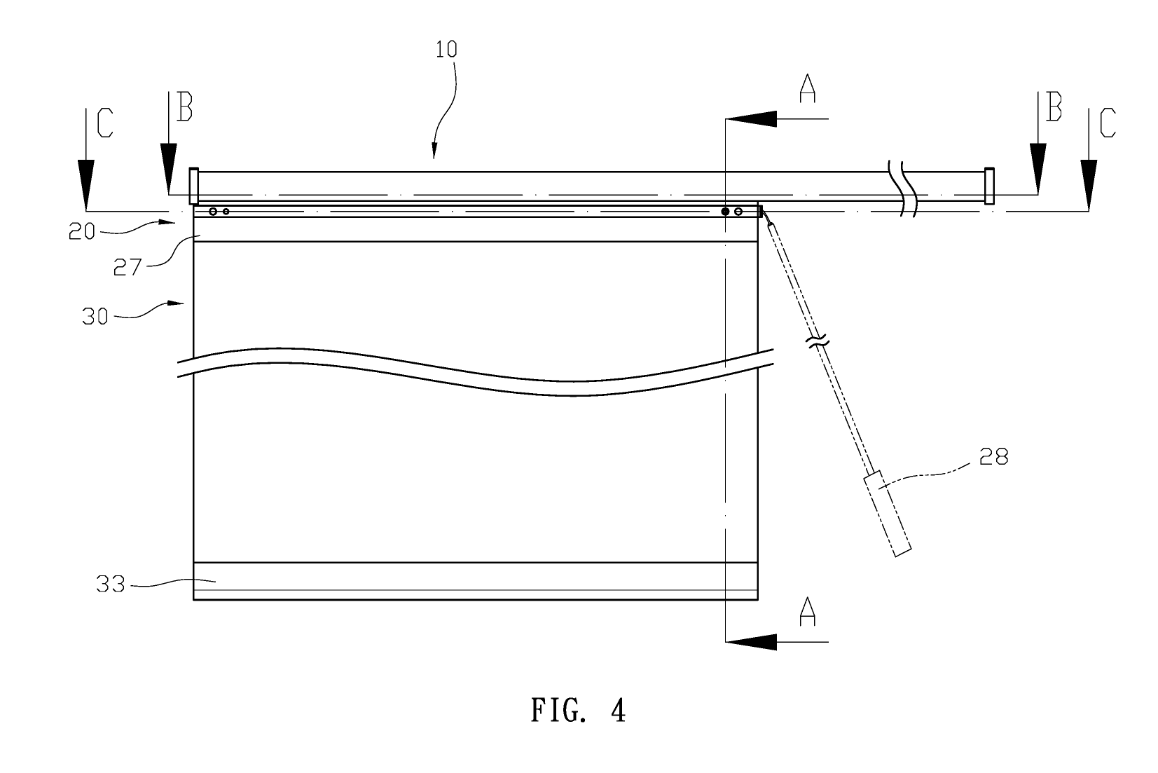

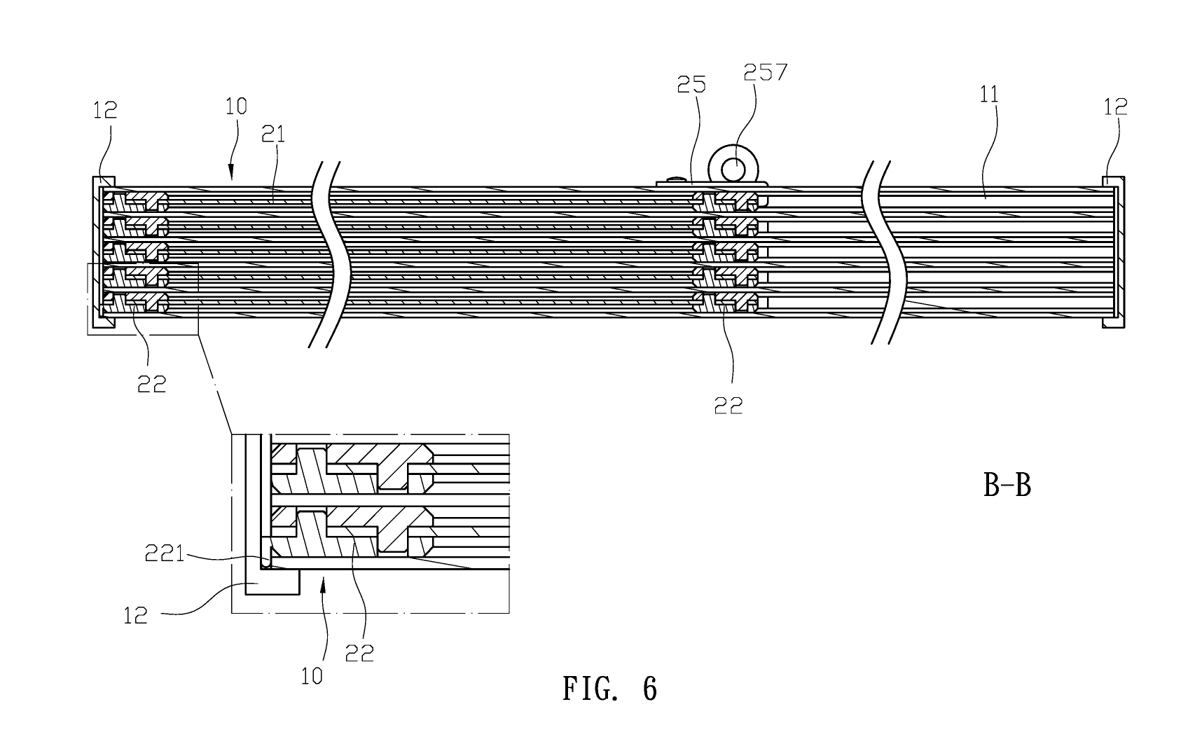

Structurally, referring to FIGS. 1 to 6, each of the track bars (20) has the second sliding member (25) partially positioned in the engaging groove (23) adjacent to the first end of the track bar (20), and the first locating protrude (251) of the second sliding member (25) is engaged with the first engaging hole (231) of the engaging groove (23). Furthermore, the locating bolt (253) is configured to penetrate through the second sliding member (25) to engage with the second engaging hole (232) to secure a position of the second sliding member (25), and the portion of the second sliding member (25) protruding from the engaging groove (23) is configured to couple in the sliding groove (24) of the adjacent track bar (20). Also, the engaging recess (256) of the second sliding member (25) is configured to be engaged by the hook portion (254) of the second sliding member (25) of the adjacent track bar (20). Moreover, the blocking member (26) is coupled in the sliding groove (24) adjacent to the second end of the track bar (20), and the second locating protrudes (261) at the top edge and the bottom edge of the blocking member (26) are configured to be coupled with the sliding groove (24) to limit the position of the blocking member (26). Additionally, the third locating protrude (262) of the blocking member (26) is configured to engage with the third engaging hole (241). The two adjacent track bars (20) are connected through the second sliding member (25) that the second sliding member (25) is simultaneously coupled in the engaging groove (23) of one track bar (20) and in the sliding groove (24) of the adjacent track bar (20). When the window blinds are at an unexpanded position, the track bars (20) are parallel. When the window blinds is horizontally pulled out for use, the track bars (20) are driven one by one in a manner that the blocking member (26) of a first shifted track bar (20) is configured to move toward and push the second sliding member (25) of a second track bar (20) thereby horizontally moving the second track bar (20), and, similarly, the moved second track bar (20) is configured to use the blocking member (26) thereof to push the second sliding member (25) of a third track bar (20) thus horizontally moving the third track bar (20), and following track bars (20) are driven in the same manner until the window blinds is fully expanded. Furthermore, each of the track bars (20) has the connecting groove (27) at the lower portion thereof, and the connecting groove (27) is configured to connect to the blind (30). Each of the blinds (30) has the strip (31) at the upper edge thereof, and the strip (31) is configured to be received in the connecting groove (27). Each of the two lateral ends of the strip (31) has the cutting edge (313) to enable the strip (31) to be coupled in the connecting groove (27), and a position of the strip (31) is configured to be limited by the blocking edges (271). Moreover, the locating head (312) of the strip (31) is adapted to bear against an inner wall of the connecting groove (27), and the friction between the locating head (312) and the connecting groove (27) is configured to secure the blind (30) in the connecting groove (27). In addition, the lower edge of the blind (30) is connected to the strip (31) which further has the weight (33) at the lower portion thereof. Thereafter, each of the pairs of first sliding members (22) is configured to couple together to clamp the guiding member (21), and the pairs of the first sliding members (22) are adapted to be respectively received into the rail portions (11). Besides, the sliding groove (24) of the outermost track bar (20) is not coupled with any second sliding member (25) such that the outermost track bar (20) has no the blocking member (26). Also, the first sliding member (22) of the outermost track bar (20) has an engaging protrude (221) to engage with an edge of the headrail (10) (as shown in FIG. 3-2). On the other hand, for the innermost track bar (20), the portion of the second sliding member (25) protruding from the engaging groove (23) is not coupled with any sliding groove (24), and a lock ring (257) is installed on an outer surface of the second sliding member (25) of the innermost track bar (20) (as shown in FIG. 3-4), and the lock ring (257) is adapted to connect to a lever (28) to move the window blinds. At last, the two covers (12) respectively couple with the two lateral ends of the headrail (10) to complete the installation of the window blinds.

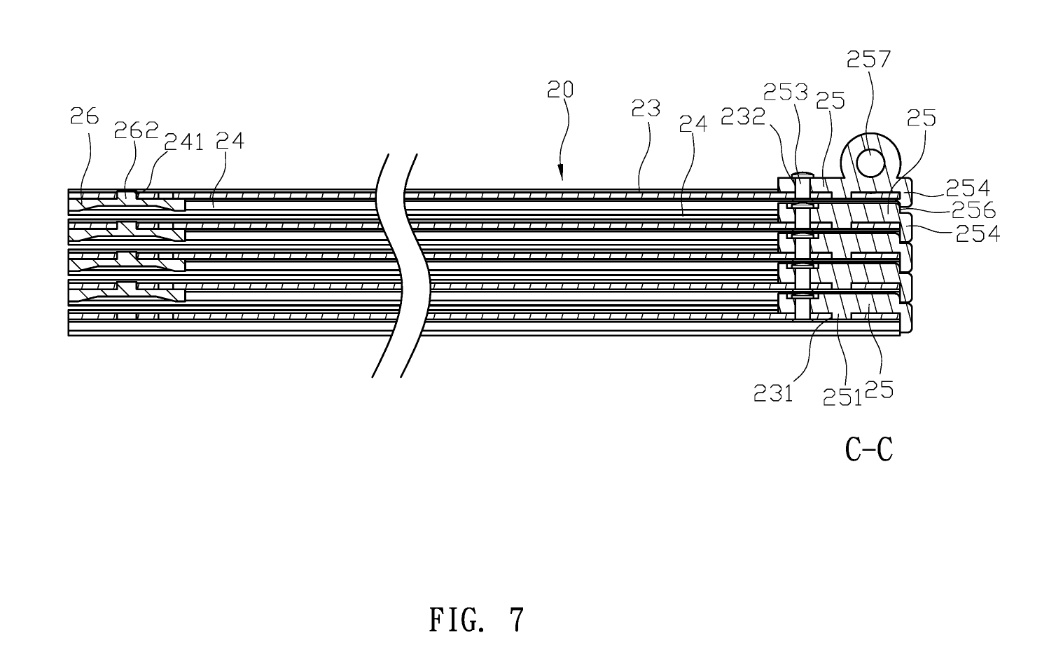

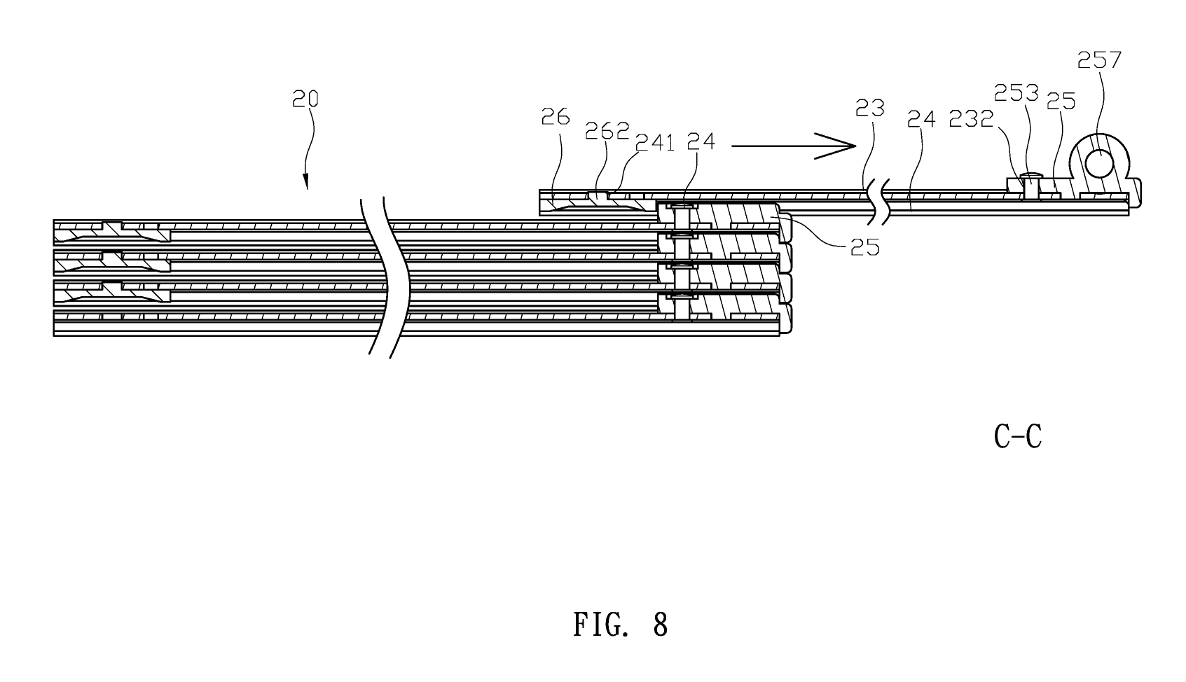

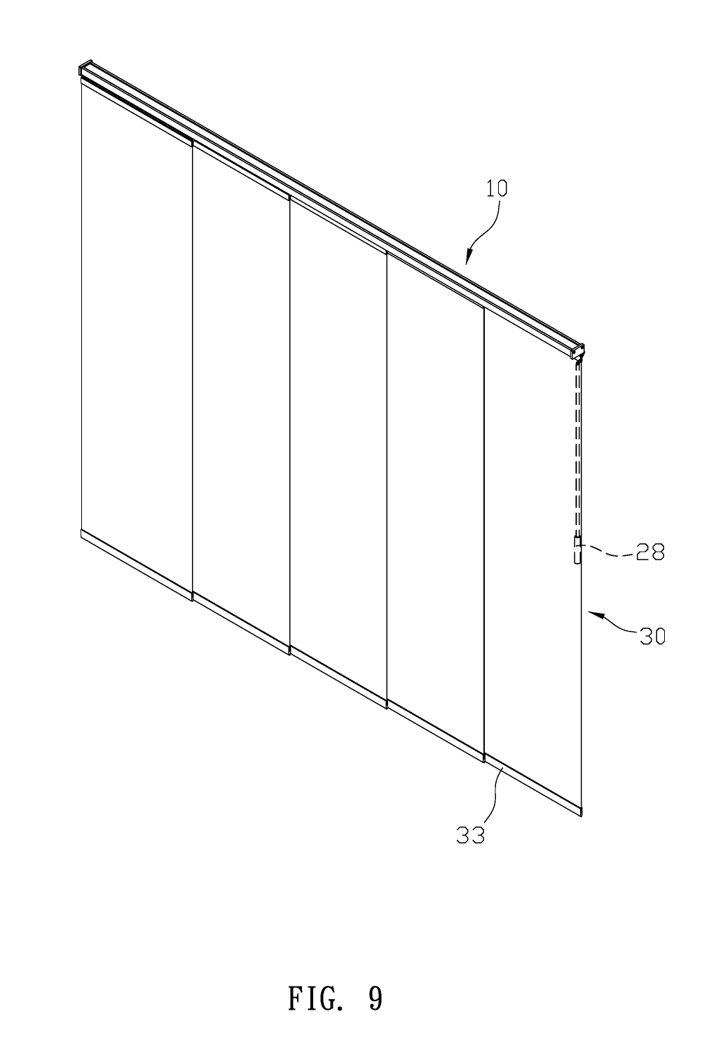

In actual application, referring to FIGS. 1 and 7 to 9, through the headrail (10), the window blinds of the present invention can be applied to different types of windows for adjusting indoor lighting conditions. When the window blinds is at the unexpanded position, the track bars (20) with the blinds (30) are arranged parallel at a second end of headrail (10). When the window blinds needs to be horizontally pulled out for use, a user can pull the lever (28) on the innermost track bar (20) toward a first end of the headrail (10). Also, through the blocking members (26) pushing the second sliding members (25) one by one, the track bars (20) are configured to be driven in sequence, and the window blinds are gradually expanded. Moreover, the engaging protrude (221) of the first sliding member (22) of the outermost track bar (20) is configured to engage with the edge of the headrail (10) to enable the blinds (30) to block lights.

Conversely, the user also can pull the lever (28) to move back the window blinds back to the unexpanded position, and the sliding groove (24) of the innermost track bar (20) is configured to have shift relative to the second-last sliding member of the adjacent track bar (20) toward the first end of the headrail (10), and the hook portion (254) of the second sliding member (25) of the innermost track bar (20) is adapted to bear against and push on the engaging recess (256) of the second-last sliding member (25) of the adjacent track bar (20), and the track bars (20) are configured to be driven one by one and moved back to the unexpanded positions in sequence, thereby adjusting indoor lighting conditions.

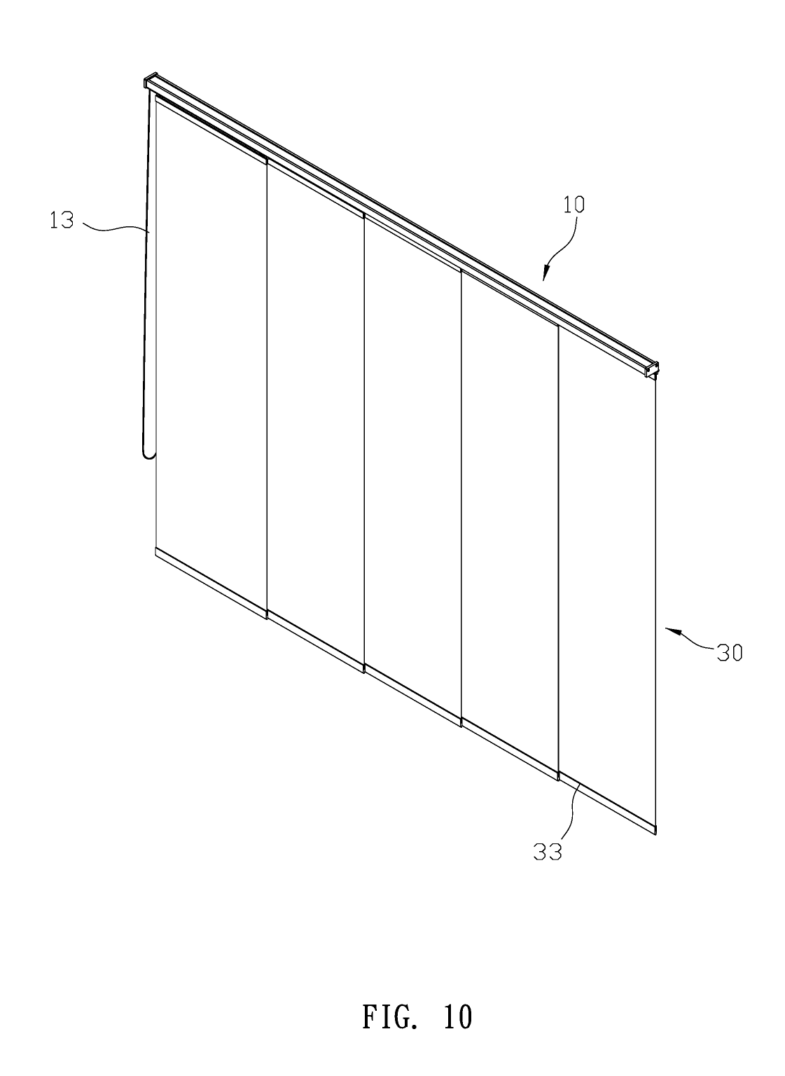

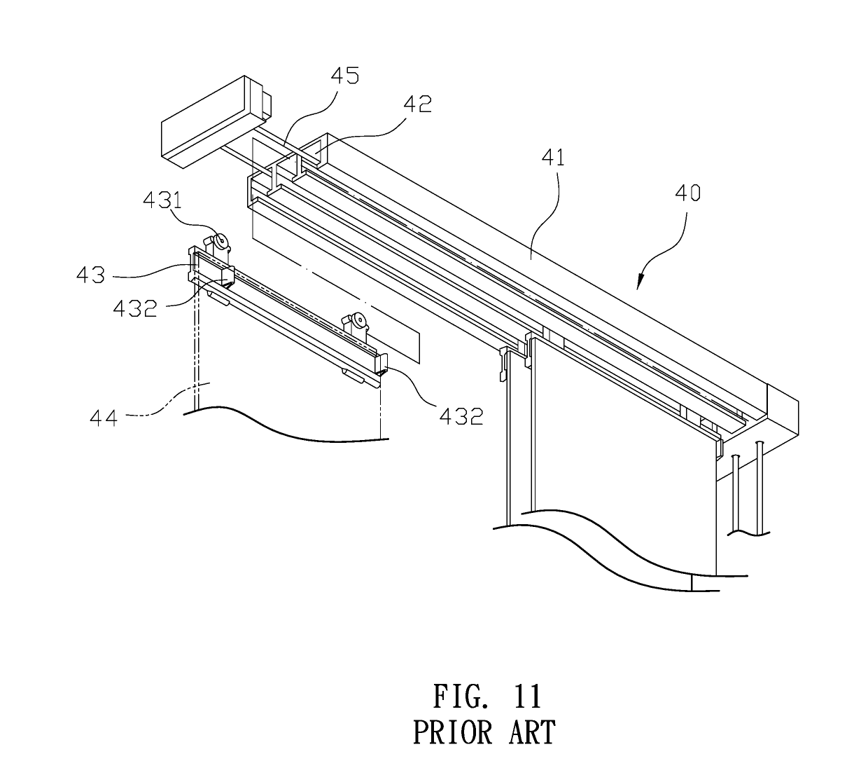

In one embodiment, referring to FIG. 10, the track bars (20) are connected to and moved through a lift cord (13).

Comparing with conventional window blinds, the present invention is advantageous because: (i) the guiding members (21) of the track bars (20) are arranged and limited in the rail portion (11) of the headrail (10) through the first sliding members (22), thereby enabling the window blinds to be assembled and used easily and reducing the sizes of the headrail (10) and the track bars (20); (ii) each of the blinds (30) is sewed with the strip (31) at the upper edge thereof to enhance strength, and each of the two lateral ends of the strip (31) has the cutting edge (313) to enable the blind (30) to be easily installed on the track bar (20); (iii) the strip (31) received in the connecting groove (27) can enable the blind (30) to be firmly secured on the track bar (20), thereby lowering labor costs; and (iv) the locating head (312) formed at the upper end of the strip (31) is adapted to bear against the inner wall of the connecting groove (27), and the friction between the locating head (312) and the connecting groove (27) is configured to secure the blind (30) on the track bar (20).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A window blinds comprising:
a headrail having a plurality of parallel rail portions, and each of rail portions comprising a block portion at a bottom portion thereof, and two covers respectively covering two lateral ends of the headrail;
a plurality of track bars; each of the track bars having a guiding member formed at an upper portion thereof, and the guiding member configured to be received in the rail portion of the headrail; each of pairs of first sliding members configured to couple together to clamp the guiding member, and the pairs of the first sliding members respectively received in the rail portions; each of the track bars having a horizontal engaging groove at a middle portion of one surface thereof and comprising a horizontal slide groove on the other surface thereof located at a position corresponding to the engaging groove; each of the engaging grooves coupled with a second sliding member adjacent to a first end of the track bar, and the second sliding member having a hook portion which is configured to extend from a first end of the engaging groove to a first end of the sliding groove; the thickness of the second sliding member being greater than the depth of the engaging groove such that a portion of the second sliding member, which protrudes from the engaging groove, configured to couple in the sliding groove of one adjacent track bar; each of the second sliding members having an engaging recess which is formed at a position corresponding to the hook portion of the adjacent track bar when the track bars located side by side; each of blocking members configured to be coupled in the sliding groove adjacent to a second end of the track bar; each of the track bars comprising a connecting groove at a lower portion thereof, and a lower portion of the connecting groove having two blocking edges respectively protruding from two inner surfaces thereof at corresponding positions; and
a plurality of blinds; each of the blinds connected to a strip at an upper edge thereof, and each of the strips, which is made of plastic material, configured to be coupled in the connecting groove of the track bar; the strip configured to clamp and cover the upper edge of the blind, and the strip and the blind adapted to be sewed together through a row of horizontal stitches; each of two lateral surfaces of the strip having a flat surface, and an arc-shaped locating head formed at an upper end of the strip; and each of two lateral ends of the strip comprising a cutting edge.

2. The window blinds of claim 1, wherein each of the engaging grooves has a first engaging hole and a second engaging hole adjacent to the first end of the track bar while each of the sliding grooves comprises a third engaging hole adjacent to the second end of the track bar.

3. The window blinds of claim 2, wherein each of the second sliding members comprises a first locating protrude and a through hole, and the first locating protrude is configured to engage with the first engaging hole while the through hole is adapted to align with the second engaging hole; a locating bolt is configured to penetrate through the through hole and the second engaging hole to secure the second sliding member on the track bar.

4. The window blinds of claim 1, wherein a locating member protruding from an upper surface of the second sliding member is configured to limit the second sliding member in the sliding groove of the adjacent track bar.

5. The window blinds of claim 2, wherein each of the blocking members has a plurality of second locating protrudes at a top edge and a bottom edge thereof, and the second locating protrudes are configured to be coupled in the sliding groove of the track bar, and a third locating protrude protruding from a lateral surface of the blocking member is adapted to engage with the third engaging hole of the sliding groove.

6. The window blinds of claim 1, wherein the portion of the second sliding member of the innermost track bar protruding from the engaging groove is not coupled with the sliding groove, and a lock ring installed on an outer surface of the second sliding member of the innermost track bar is adapted to connect to a lever to move the window blinds.

7. The window blinds of claim 1, wherein the track bars are connected to and moved through a lift cord.

8. The window blinds of claim 1, wherein the sliding groove of the outermost track bar is not coupled with the second sliding member such that the outermost track bar has no the blocking member; the first sliding member of the outermost track bar has an engaging protrude to engage with an edge of the headrail.

9. The window blinds of claim 1, wherein each of the blinds is connected to the two strips at the upper edge and a lower edge thereof, and the strip at the lower edge of the blind has a weight at a lower portion thereof.
